(19) United States
(12) Patent Application Publication
(10) Pub. No.: US 2024/0094098 A1
(43) Pub. Date: Mar. 21, 2024

(54) VARIABLE POWER COLD MICROWAVE TISSUE PROCESSOR

(71) Applicant: Pathronix Corp., Concord (CA)

(72) Inventors: Behrouz Oveisi, Newmarket (CA); Seyed Mohsen Moaddab, Khoy (IR)

(73) Assignee: Pathronix Corp., Concord, ON (CA)

(21) Appl. No.: 18/255,519

(22) PCT Filed: Dec. 1, 2021
(86) PCT No.: PCT/CA2020/000130

§ 371 Date: Jun. 1, 2023

(51) Int. Cl. G01N 1/31; G01N 1/34; G01N 1/44

(52) U.S. Cl. CPC G01N 1/31; G01N 1/34; G01N 1/44; G01N 2001/305

(57) ABSTRACT

A method and an apparatus that utilizes a flow-through processing and embedding technique for rapidly embedding cells is provided. A microwave heating process using a cooling system is utilized to keep the reagent and the tissue samples at a predefined temperature during the process. This flow-through processing maximizes the efficiency of cell recovery and of extractions during embedding, thereby decreasing the amount of cellular sample required, minimizing the amount of time for processing, and minimizing the amount of reagents needed for embedding.

### FIELD OF THE INVENTION

The present invention relates in general to methods and devices for preparing cells for microscopic examination, and in particular to tissue processing for embedding cells and tissues in a solid substrate, for later microtome cutting.

### BACKGROUND OF THE INVENTION

Many disease processes can only be diagnosed on the basis of histologic or cytologic examination using a light microscope. For instance, direct pathological analysis of a cell is needed to determine if a tumor is benign or malignant. Such analysis requires thin slices of the sample tissue which are obtained by first embedding the tissue in a solid material, a process called tissue processing, and then cutting the embedded tissue with a microtome. Tissue processing comprises of the following steps: (1) Water removal from the sample. In order to do this, a dehydrating reagent, usually an alcohol, which is miscible with water is used to remove the water. The dehydrating reagent is diffused into and out of sample tissue multiple times to remove the water content of the tissue. This step is referred to as dehydration steps. (2) Replacement of the dehydrating agent with a clearing reagent, xylene, which is miscible with alcohol, is typically used for this process. In this step, all fatty substances are also removed by the solution. (3) Finally, the clearing reagent, the xylene, is removed and replaced with a histological substance, which is usually a paraffin wax, which is miscible with xylene but not with most alcohols or water. Prior to dehydration step, however, the tissue sample must be immersed in a fixative reagent to prevent autolysis, putrefaction and other unwanted cellular changes. There are a large number of histological fixatives. The most commonly used fixatives is 10% neutral buffered (NB) formaldehyde solutions.

Tissue processing is routinely done on an instrument named Tissue Processor. One of the issues with the current processors is the time it takes to complete these processes. It typically takes anywhere from 8 to 16 hours to complete the process because the extraction of water, alcohol, fats, and xylene in the tissue processor is time consuming. Turnaround time is an important quality indicator in pathology and on average, about a quarter (24%) of routine pathology cases are not reported on time and do not meet the accepted level of the College of American Pathologists' (CAP) standard turnaround time, which states at least 90% of routine pathology cases should be reported and verified within two days.

Tissue samples taken out of the body will decompose due to loss of blood supply and oxygen, accumulation of the products of metabolism, action of autolytic enzymes, and putrefaction by bacteria. There are also other difficulties in this process, including: softness of tissues renders the process of section cutting very difficult; tissue doesn't have clear optical contrast for good morphologic examination, and tissue doesn't act as a mordant.

Another issue with the current processes is that they use Formalin as a fixative reagent to preserve the tissue sample. Formalin is a hazardous chemical. It is a potent and colourless substance that is commonly used in hospitals and medical laboratories as a disinfectant, and preservative of anatomical specimens. Its toxicity is well-documented, as it may trigger severe allergic reactions such as difficulty breathing, asthma attacks, respiratory irritation, headaches, and watery/burning eyes. Formalin is a skin irritant, a carcinogen, and if ingested can be fatal.

Immunohistochemistry (IHC) is routinely used in diagnostic pathology to detect infectious agents, to immunophenotype neoplastic cells, and to prognosticate neoplastic diseases. Formalin fixation is considered a limiting factor for IHC because formalin can cross-link antigens and mask epitopes. Prolonged formalin fixation is presumed to result in decreased antigen detection Elimination of Formalin may improve the IHC results significantly. The present invention is aimed to resolve the above mentioned issues.

### SUMMARY OF THE INVENTION

The present invention provides a method and apparatus that utilizes a flow-through processing and embedding technique for rapidly embedding cells. The present tissue processing method, comprises of the following steps. The tissue samples are placed inside an especially designed microwave oven that is attached to a cooling cycle. The microwave oven is filled with a fixative reagent, and the fixative reagent is heated to a set temperature in the range of 40-60° Celsius. The temperature is then kept at that set temperature by circulating the fixative reagent through a temperature controller system and while in the microwave oven. The fixative reagent is then removed and replaced with a first dehydrating reagent, which is then heated to a set temperature in the range of 40-60° Celsius. Again, the liquid temperature is kept constant. The process is repeated by draining the first dehydrating reagent and replacing it first with a second dehydrating reagent and then by a clearing agent. Once the tissue samples are embedded with a clearing agent, they are transferred to a paraffin oven. The paraffin oven is filled with paraffin, and the whole system is heated until paraffin replaces the clearing agent, resulting in paraffin embedded tissues.

This flow-through processing maximizes the efficiency of cell recovery and of extractions during embedding, thereby decreasing the amount of cellular sample required, minimizing the amount of time for processing, and minimizing the amount of reagents needed for embedding. The method and apparatus also automatically places cells at the plane in the cell block where they need to be sectioned without diluting them with carrier substances. In addition, the method and apparatus minimizes or eliminates the potential for mislabeling of a cell block or cross contamination between two different cell samples. Finally, the method allows customization and standardization of cell preservation or cell embedding conditions to facilitate cell research.

The first objective of the present invention is to provide a method to provide a superior tissue specimen quality.

The second objective of the present invention is to fully eliminate Formalin and Xylene in the process.

The third objective of the present invention is to process any kind of tissues, even fatty tissues and any density, and through a single protocol.

The fourth objective of the present invention is to provide a closed and sealed reagent containers for increasing user safety.

The fifth objective of the present invention is to provide a short processing time (reducing the current times by 45%-85%).

The sixth objective of the present invention is to eliminate the antigen retrieval step for proper IHC staining.

The seventh objective of the present invention is to provide a low temperature process for protecting tissue structure.

The eighth objective of the present invention is to have a cost-effective system by using only 4 reagents, reducing technician cost and shortening processing time. And the nineth objective of the present invention is to reduce pre-analytical errors by eliminating tissue sorting and protocol choose errors

### BRIEF DESCRIPTION OF THE DRAWINGS

The invention can be more fully understood from the following detailed description taken in conjunction with the accompanying drawings, in which:

FIG. 1 is a detailed view of one embodiment of the present tissue processing method.

### DETAILED DESCRIPTION OF PREFERRED EMBODIMENTS

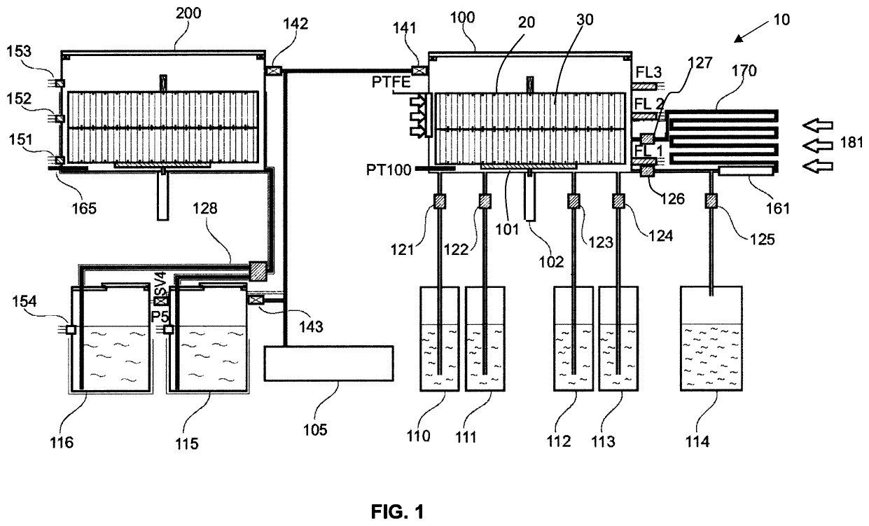

The present invention provides a method and apparatus for tissue processing to prepare a cell block for sectioning with a microtome. The tissue processing apparatus 10 of the present invention is designed as a flow-through system and is shown in FIG. 1. It comprises of a microwave heated processing oven 100 configured to receive a basket 20 of tissue sample holders 30. The processing oven is configured to receive a variety of fluids including fixative, dehydrating (alcohol) and clearing reagents, which are held in a fixative reagent container 110, dehydrating reagent containers 111 and 112, and clearing reagent container 113, and are connected to the oven through flow paths having ball valves 121, 122, 123, and 124, respectively.

Fixation Process

The fixatives reagent comprises: (1) Phosphate buffer saline+0.1 to 1.0-gram/L thymol or (2) Low concentration of formalin 0.1% to 1% NB. In the

Fixation: In step one of the process, tissue samples 30 are placed in the processing oven 100 and the fixative reagent 110 is transferred to the processing oven 100 by a negative pressure that is generated inside the oven using a vacuum pump 105. The negative pressure is generated by opening valve 141 to generate negative pressure of 200 to 700 mbar in the process oven. The valve 121 of the fixative flow line is opened to allow fixative to fill the oven. Fluid level meters, FL1, FL2, and FL3 measure the fluid level. The level of the reagent is controlled by a liquid level sensor FL3. When the reagent reaches a pre-determined level, the vacuum stops working, and the ball valve 121 is closed. A variety of level sensors, including capacitive sensors or fiber optic sensors can be used. A variable power microwave having a power in the range of 200 to 700 watts, emits energy into the chamber of the oven through a PTFE sealed window. Stirrer motor 102 start working at 40 to 400 rpm. At this point, the reagent is heated by the microwave 100 to reach a temperature of 40-50° Celsius and the tissue sample holders start to turn by a rotating plate 101 having a motor 102 at 50 to 100 rpm, for protecting from hot spots and maintaining thermal homogeneity. When the reagent temperature reaches the pre-determined point (40-50° Celsius), valves 126 and 127 are opened and the circulating pump 161 stars working to eliminate reagent overheating while the microwave is working. The power of the microwave is adjusted depending of fluid level. When the duration of the fixing process reaches a set value, the reagent transfers to a waste container 114.

A cooling system 170 with a Peltier or a fan (air flow) 181 with PWM (Pulse-width modulation control), keeps the reagent temperature at the predetermined temperatures while the microwave is still working. When fixation time reaches a predetermined fixation time, the microwave turns off and a valve 125 opens allowing fluid to transfer from the processing oven 100 to a waste container 114. When all fluid level sensors FL1, FL2, and FL3 are turned off, valves 125, and 126 and 127 for the cooling system 170 are closed and the circulating pump 161 is turned off.

Dehydration Process 1

Dehydrating reagents: Ethyl alcohol 80 to 95%. Isopropyl alcohol 80 to 95%.

Dehydration step 1: Vacuum 105 and valve 141 turn on and cause negative pressure 200 to 700 mbar in process oven. Valve 122 opens and the dehydrating reagent 111 transfers to process oven 100, while flow level sensors turn on. Once flow level sensor FL3 is turned on, the vacuum is turned off and valve 122 is closed. Stirrer motor 102 starts working at 40 to 400 rpm. Variable power microwave 200 to 700 watt emits into the chamber via PTFE sealed window. The reagent gets warmed by the microwave and when the temperature reaches a predetermined dehydration, of 20° to 60° Celsius, cooling line valves 126 and 127 are opened and the circulating pump 161 starts working. Cooling system with Peltier or fan (air flow) 181 with PWM (Pulse-width modulation fan) hold the reagent temperature at the predetermined values, while the microwave is still working. When the dehydration time reaches the predetermined dehydration step 1 time, the microwave turns off and valve 125 opens. Fluid transfers from processing oven to waste container, and when all flow level sensors FL1, FL2, and FL3, are turned off, the waste tank valve 125, and the coiling line valves 126, and 127 are closed and the circulating pump 161 is turned off.

Dehydration Process 2

Dehydrating reagents: Ethyl alcohol 99.9% and Isopropyl alcohol 99.9%

Dehydration step 2: In the second dehydration process, the vacuum system and valve 141 are turned on and cause negative pressure 200 top 700 mbar in process oven. Valve 112 is opened, and the dehydrating reagent transfers to the process oven until all flow level sensors FL1, FL2, and FL3 are turned on, at which point the vacuum and flow valve 123 are turned off. Stirrer motor 102 starts working with 40 to 400 rpm. Variable power microwave, 200 to 700 watts, emits energy into the oven chamber through a PTFE sealed window. The reagent gets warm by microwave and when the temperature reaches the predetermined dehydration step 2 temperature of 20° to 60° Celsius, valves 126 and 127 are opened and the circulating pump 161 starts working. Cooling system 170 with Peltier or fan (air flow) 181 with PWM controlling holds the reagent temperature at the predetermined set value while the microwave is still working. When the dehydration time reaches the predetermined dehydration step 2 time, the microwave turns off and valve 125 opens. Fluid transfers from the processing oven to waste container 114, until all level sensors FL1, FL2, and FL3, are turned off, then valves 126 and 127 of the cooling system are closed and the circulating pump is turned off.

Clearing Process:

Clearing reagents: (1) 5% to 95% Hexane, +5% to 95% Isopropyl alcohol 99.9%. (2) 5% to 95% Heptane, 5% to 95% Isopropyl alcohol 99.9%. (3) 5% to 95% Hexane, 5% to 95% Heptane, +5% to 95% Isopropyl alcohol 99.9%.

Clearing process steps: Vacuum 105 is turned on and valve 141 is opened to cause negative pressure 200 to 700 mbar in process oven. Valve 113 is opened and the clearing reagent transfers to the process oven, while level sensors FL1, FL2, FL3 check the level as the vacuum. Stirrer motor starts working at 40 to 400 rpm. Variable power microwave emits 200 to 700 watts of energy into the chamber via PTFE sealed window. The reagent gets warm by microwave and when the temperature reaches the predetermined clearing temperature set value (20° to 60° Celsius), cooling flow line valves 126 and 127 open and the circulating pump starts working. When the clearing time reaches the predetermined clearing time, the microwave turns off and valve 125 opens. Fluid transfers from processing oven to waste container, and when all level sensors FL1, FL2, FL3 are off, then valves 125, 126, and 127 are closed and the circulating pump is turned off.

Paraffinization Process

Paraffinization steps: Once the clearing step is completed, the basket is transferred into a paraffin oven 200. In the paraffin step, the tissue holder is turned at 50 to 100 rpm for thermal homogeneity. The melted paraffin transfers from paraffin container 115 to paraffin oven 200 and vacuum. The heater starts working to reduce the boiling point of the remaining clearing reagent in tissues to replace it with melted paraffin. After a specified time, the paraffin transfers back to the paraffin container 115 and the same process is repeats through a second paraffin container 116. At the end of the this process the tissues are ready for embedding.

The present tissue processing method has several advantages over the currently available methods. One that it significantly reduces the processing time. Another that is does not use Formalin and Xylene, which are both environmentally hazardous substances. It can also process a wide range of tissue sample sizes all in the same cycle and through a single protocol. It also eliminates the antigen retrieval step for proper IHC staining.

The present method is referred to as Cold Microwave (VCM) tissue processor, since the fluid temperatures are kept low. This process has a substantially shortens time from specimen reception to diagnosis without compromising the overall quality of the histologic section. This allows for biopsy and definitive surgery on the same day, thereby decreasing patient expense and the requirement for multiple trips between home and the referral center.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

1-11. (canceled)

12. A fat-insensitive and size-insensitive rapid tissue processor comprising:
at least one tissue processing chamber configured to receive tissue samples;
at least one reagent chamber comprising a clearing reagent chamber fluidly coupled to the at least one tissue processing chamber such that a clearing reagent is circulated into contact with at least one pre-dehydrated tissue sample in the at least one tissue processing chamber, the clearing reagent comprising a polar solvent and a non-polar solvent;
a variable power microwave operably coupled to emit power into the at least one tissue processing chamber;
a flow-circulating cooling system operably coupled to control a temperature of fluid being circulated in the at least one tissue processing chamber;
a first histologic substance chamber containing a first histologic substance; and,
a second histologic substance chamber containing a second histologic substance isolated from the first histologic substance chamber,
wherein at least the variable power microwave and the flow-circulating cooling system are configured such that, during a clearing process:
a total maximum emission from the variable power microwave into the at least one tissue processing chamber is 700 Watts×duration of the clearing process; and
a temperature of the clearing reagent does not exceed a predetermined set value,
such that, in the presence of existing dehydrating agent and existing fatty substances in the tissue sample, the clearing reagent removes the existing dehydrating agent and the existing fatty substances, and
each of the first histologic substance chamber and the second histologic substance chamber are operably coupled to the at least one tissue processing chamber such that, after the clearing process is performed:
the first histologic substance chamber is operated into fluid communication with the at least one tissue processing chamber such that the first histologic substance is brought into contact with the tissue sample for a period of time before transferring the first histologic substance back into the first histologic substance chamber, and
subsequently, the second histologic substance chamber is operated into fluid communication with the at least one tissue processing chamber such that the second histologic substance is brought into contact with the tissue sample.

13. A tissue processor comprising:
at least one tissue processing chamber configured to receive tissue samples;
at least one reagent chamber comprising a clearing reagent chamber fluidly coupled to the at least one tissue processing chamber such that clearing reagent is circulated into contact with at least one pre-dehydrated tissue sample in the at least one tissue processing chamber, the clearing reagent comprising a polar solvent and a non-polar solvent;
a variable power microwave operably coupled to emit power into the at least one tissue processing chamber; and,
a flow-circulating cooling system operably coupled to control a temperature of fluid being circulated in the at least one tissue processing chamber,
wherein at least the variable power microwave and the flow-circulating cooling system are configured such that, during a clearing process:
a total maximum emission from the variable power microwave into the at least one tissue processing chamber is 700 Watts×duration of the clearing process, and
a temperature of the clearing reagent does not exceed a predetermined set value,
such that, in the presence of existing dehydrating agent and existing fatty substances in the tissue sample, the clearing reagent removes the existing dehydrating agent and the existing fatty substances.

14. The tissue processor of claim 13, the at least one reagent chamber further comprising:
a first histologic substance chamber containing a first histologic substance; and,
a second histologic substance chamber containing a second histologic substance isolated from the first histologic substance chamber,
wherein each of the first histologic substance chamber and the second histologic substance chamber are operably coupled to the at least one tissue processing chamber such that, after the clearing process is performed:
the first histologic substance chamber is operated into fluid communication with the at least one tissue processing chamber such that the first histologic substance is brought into contact with the tissue sample for a period of time before transferring the first histologic substance back into the first histologic substance chamber, and
subsequently, the second histologic substance chamber is operated into fluid communication with the at least one tissue processing chamber such that the second histologic substance is brought into contact with the tissue sample.

15. The tissue processor of claim 14, wherein:
the at least one tissue processing chamber comprises a first tissue chamber and a second tissue chamber,
the clearing reagent chamber is fluidly coupled to the first tissue processing chamber, and
the first histologic substance chamber and the second histologic substance chamber are each fluidly coupled to the second tissue chamber,
such that the clearing process is performed on the tissue sample in the first tissue processing chamber and the first histologic substance and the second histologic substance are each brought into contact with the tissue sample in the second processing chamber.

16. The tissue processor of claim 14, wherein the first histologic substance and the second histologic substance each comprise paraffin.

17. The tissue processor of claim 14, wherein the polar solvent comprises an alkanol, and the non-polar solvent comprises an alkane.

18. The tissue processor of claim 17, wherein the alkanol comprises isopropyl alcohol.

19. The tissue processor of claim 17, wherein the alkane comprises at least one of: heptane, and hexane.

20. The tissue processor of claim 13, wherein the clearing reagent is xylene free and formalin free.

21. The tissue processor of claim 13, the at least one reagent chamber further comprising a dehydration reagent chamber operably coupled to be selectively operated into fluid communication with the at least one tissue processing chamber such that dehydrating reagent is circulated into contact with the tissue sample.

22. The tissue processor of claim 21, wherein the dehydrating reagent is formalin free and xylene free.

23. The tissue processor of claim 13, the at least one reagent chamber further comprising a fixative reagent chamber operably coupled to be selectively operated into fluid communication with the at least one tissue processing chamber such that fixative reagent is circulated into contact with the tissue sample.

24. The tissue processor of claim 23, wherein the fixative reagent is xylene free and comprises a maximum of 1% formalin.

25. The tissue processor of claim 23, wherein the fixative reagent comprises at least one of: ethyl alcohol, and isopropyl alcohol.

26. The tissue processor of claim 13, wherein the at least one reagent chamber is coupled to the at least one tissue processing chamber in a flow-through manner such that corresponding reagents may be selectively operated into contact with the tissue sample.

27. A tissue processor comprising:
at least one tissue processing chamber configured to receive tissue samples; and,
at least one reagent chamber comprising:
a first histologic substance chamber containing a first histologic substance; and,
a second histologic substance chamber containing a second histologic substance isolated from the first histologic substance chamber,
wherein each of the first histologic substance chamber and the second histologic substance chamber are operably coupled to the at least one tissue processing chamber such that, after a clearing process is performed:
the first histologic substance chamber is operated into fluid communication with the at least one tissue processing chamber such that the first histologic substance is brought into contact with the tissue sample for a period of time before transferring the first histologic substance back into the first histologic substance chamber, and
subsequently, the second histologic substance chamber is operated into fluid communication with the at least one tissue processing chamber such that the second histologic substance is brought into contact with the tissue sample.

28. The tissue processor of claim 27, wherein the first histologic substance comprises paraffin.

29. The tissue processor of claim 27, wherein the second histologic substance comprises paraffin.

30. The tissue processor of claim 27, further comprising:
a variable power microwave operably coupled to emit power into the at least one tissue processing chamber; and,
a flow-circulating cooling system operably coupled to control a temperature of fluid being circulated in the at least one tissue processing chamber,
wherein:
the at least one reagent chamber further comprises a clearing reagent chamber fluidly coupled to the at least one tissue processing chamber such that clearing reagent is circulated into contact with at least one pre-dehydrated tissue sample in the at least one tissue processing chamber, the clearing reagent comprising a polar solvent and a non-polar solvent, and
at least the variable power microwave and the flow-circulating cooling system are configured such that, during a clearing process:
a total emission from the variable power microwave into the at least one tissue processing chamber is 700 Watts×duration of the clearing process; and,
a temperature of the clearing reagent does not exceed a predetermined set value,
such that, in the presence of existing dehydrating agent and existing fatty substances in the tissue sample, the clearing reagent removes the existing dehydrating agent and the existing fatty substances.

31. The tissue processor of claim 30, wherein:
the clearing reagent is xylene free and formalin free
the polar solvent comprises an alkanol, and
the non-polar solvent comprises an alkane.

32. The tissue processor of claim 30, wherein:
the at least one tissue processing chamber comprises a first tissue chamber and a second tissue chamber,
the clearing reagent chamber is fluidly coupled to the first tissue processing chamber, and
the first histologic substance chamber and the second histologic substance chamber are each fluidly coupled to the second tissue chamber, such that the clearing process is performed on the tissue sample in the first tissue processing chamber and the first histologic substance and the second histologic substance are each brought into contact with the tissue sample in the second processing chamber.

33. The tissue processor of claim 27, the at least one reagent chamber further comprising a dehydration reagent chamber operably coupled to be selectively operated into fluid communication with the at least one tissue processing chamber such that dehydrating reagent is circulated into contact with the tissue sample.

34. The tissue processor of claim 33, wherein the dehydrating reagent is formalin free and xylene free.

35. The tissue processor of claim 33, the at least one reagent chamber further comprising a fixative reagent chamber operably coupled to be selectively operated into fluid communication with the at least one tissue processing chamber such that fixative reagent is circulated into contact with the tissue sample.

36. The tissue processor of claim 35, wherein the fixative reagent is xylene free and comprises a maximum of 1% formalin.

37. The tissue processor of claim 27, wherein the at least one reagent chamber is coupled to the at least one tissue processing chamber in a flow-through manner such that corresponding reagents may be selectively operated into contact with the tissue sample.
